(19) United States
(12) Patent Application Publication
(10) Pub. No.: US 2010/0025426 A1
(43) Pub. Date: Feb. 4, 2010

(54) DOSING DEVICE

(76) Inventors: Hans-Peter Wild, Eppelheim (DE); Wolfgang Tilz, Schwetzingen (DE)

Correspondence Address: STROOCK & STROOCK & LAVAN LLP, 180 MAIDEN LANE, NEW YORK, NY, 10038, US

(21) Appl. No.: 12/296,807

(22) PCT Filed: Apr. 12, 2007
(86) PCT No.: PCT/EP2007/003266

§ 371 Date: Sep. 30, 2009

(30) Foreign Application Priority Data
Apr. 12, 2006 (EP) 06007735.1

(51) Int. Cl. B67D 7/06; B67D 1/08; B65D 88/54

(52) U.S. Cl. 222/1; 222/148; 222/334

(57) ABSTRACT

A system for withdrawing a quantity of a product from a product stream may include a product flow channel through which a volume of products may flow, a chamber for receiving a quantity of the product, an opening through which the products may flow from the product flow channel into the chamber. The system preferably also includes a sealing assembly for selectively sealing the opening.

### CROSS REFERENCE TO RELATED APPLICATIONS

The present application is a national stage application under 35 U.S.C. §371 of International Application No. PCT/EP2007/003266, filed Apr. 12, 2007, which claims priority from European Patent Application No. EP06007735.1, filed Apr. 12, 2006.

### BACKGROUND OF THE INVENTION

This invention relates, in general, to an apparatus and method for a withdrawal of a controlled quantity of a product from a product flow

Most product withdrawal devices and methods currently available include filling a volume lance with a predetermined quantity of the product and moving the predetermined quantity into a withdrawal container, wherein sterilization of the withdrawal device is improbable or very limited. An example of a device and method available is provided in DE 198 01 405.

In light of the shortcomings described above, it is desirable to provide an apparatus and method of withdrawing a quantity of a product from a product stream wherein sterilization of the apparatus and/or product is facilitated.

### SUMMARY

Generally speaking, the present invention is directed toward an apparatus having a product flow channel through which a product can flow, and a chamber preferably adjacent to the flow channel for receiving a quantity, preferably a predetermined quantity of the product. A displaceable member, referred to herein as “plunger” may be provided for opening and closing the chamber, and preferably includes a first sterilization system for sterilizing the plunger such that the plunger does not contaminate the product. An embodiment of the invention may also include a second sterilization system for sterilizing the chamber prior to receiving the product. A third sterilization system may be provided to sterilize a spindle housing the rod portion of the plunger, which may further reduce the risk of product contamination.

Accordingly, it is an object of the invention to provide an apparatus and a method for providing sterilization while withdrawing a quantity of a product from a product stream.

It is further an object of the invention to provide an apparatus and a method for withdrawing a quantity of a product from a product flow that substantially reduces the risk of contamination of the product caused by the withdrawing assemblies.

It is also an object of the invention to provide an apparatus and a method for sterilizing one or more components of the withdrawing assemblies during the withdrawing process.

Another object of the invention is to provide a chamber that may be isolated from the product flow and substantially easily sterilized.

Other objects and features of the present invention will become apparent from the following detailed description, considered in conjunction with the accompanying drawing figure. It is to be understood, however, that the drawings are designed solely for the purpose of illustration and not as a definition of the limits of the invention, for which reference should be made to the appended claims.

### BRIEF DESCRIPTION OF THE FIGURES

For a fuller understanding of the invention, reference is had to the following description, taken in connection with the accompanying drawings, in which:

FIG. 1 is a schematic view of an apparatus in accordance with an embodiment of the invention in a first position;

FIG. 2 is a schematic view of the apparatus of FIG. 1 in a second position;

FIG. 3 is a schematic view of the apparatus of FIG. 2 in a third position;

FIG. 4 is a schematic view of an apparatus in accordance with an embodiment of the invention in a first position;

FIG. 5 is a schematic view of the apparatus of FIG. 4 in a second position; and

FIG. 6 is a schematic view of the apparatus of FIG. 4 in a third position.

### DETAILED DESCRIPTION

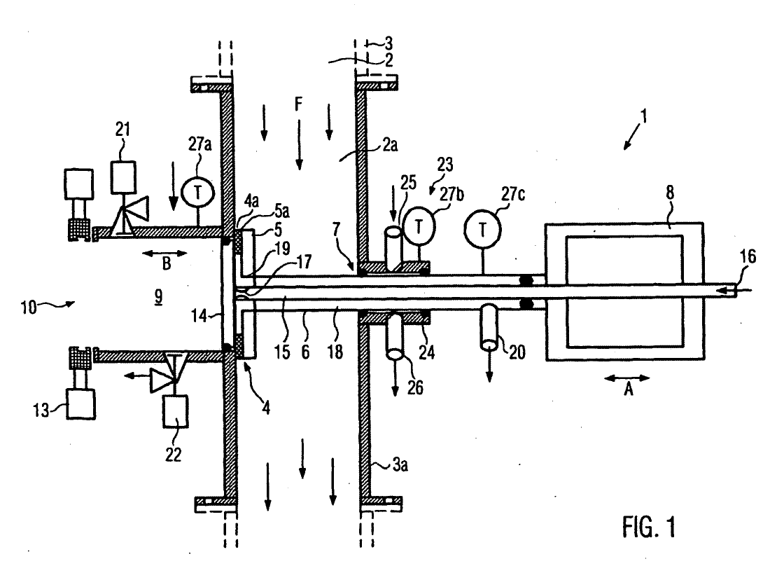

Reference is made to FIGS. 1-3, wherein a system 1 constructed and arranged according to an embodiment of the invention is illustrated. In the embodiment shown, the apparatus may include a channel 2 through which a product may flow. The product may include, by way of non-limiting example, liquid, a liquid with solids, solids, and the like, more preferably food products, such as fruit preparation and the like. System 1 may be utilized to withdraw a sample of the product to determine contamination with microorganisms, to fill a container, and the like. It is to be understood that the quantity of the product may be withdrawn for other purposes without deviating from the scope of the invention.

In the embodiments shown in FIGS. 1-3, a conduit 3 may include a channel 2 having a flow channel 2a, through which the product may flow. Flow channel 2a is preferably defined by a pipe socket 3a, which is preferably connected to conduit 3. Therefore, the product may flow within conduit 3 and thus flow channel 2a in a flow direction F.

In the embodiment shown, a chamber 9 is provided next to pipe socket 3a, preferably perpendicular to flow direction F, wherein chamber 9 opens into flow channel 2a via outlet opening 4.

System 1 may include a tubular member 6 extending into flow channel 2a through an opening 7 preferably positioned across flow channel 2a from outlet opening 4a. Preferably, opening 7 is sealed, for example, by tubular member 6 and/or sealing members 6′, such that the product, air, contaminants, etc. cannot flow in or out through opening 7. Tubular member 6 preferably includes a valve body 5 and outlet opening 4 preferably includes a valve seat. When valve body 5 contacts valve seat 4a, outlet opening 4 is preferably sealed and the product is prevented from flowing in or out of chamber 9. In accordance with the embodiment shown, valve seat 4a is constructed and arranged to face and may be at least partially within product flow channel 2a. Valve body 5 may be located within flow channel 2a and may be movable, preferably perpendicularly to flow direction F, toward valve seat 4a.

Tubular member 6 preferably houses a plunger rod 15 and is preferably selectively movable in the direction of the double headed arrow A across the flow direction F, more preferably perpendicular to flow direction F. In accordance with an exemplary embodiment of the invention, plunger rod 15 is also movable in the direction of double headed arrow A within tubular member 6. A plunger 14 may be provided, preferably connected to, more preferably fixed to plunger rod 15.

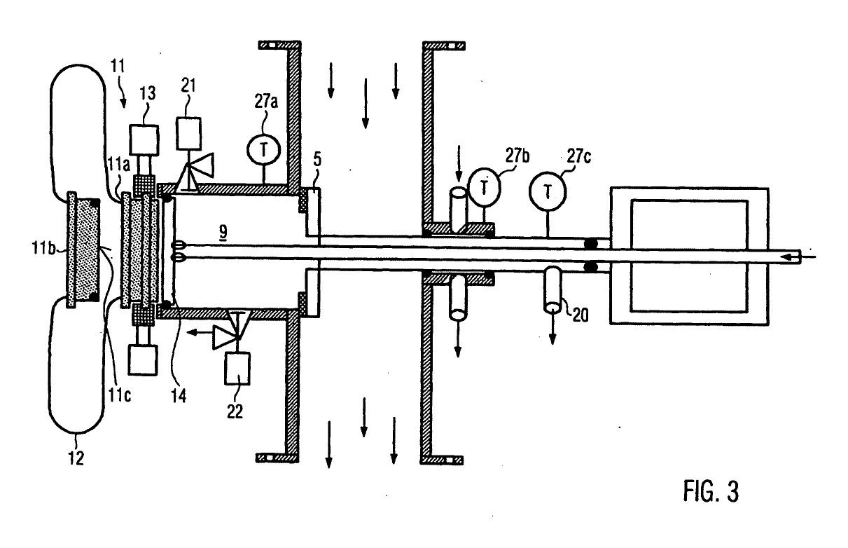

As shown in FIG. 1, plunger 14 preferably selectively forms a double-seated valve with valve body 5 when plunger rod 15 is withdrawn, preferably completely withdrawn relative to the tubular member 6. Alternatively, when plunger rod 15 is extended as shown in FIG. 3, plunger 14 preferably disengages from valve body 5, thus breaking the double-seated valve formed therewith.

In accordance with an exemplary embodiment, a drive 8 may be provided to activate and preferably control the movement of tubular member 6, and more preferably also plunger rod 15. For example, drive 8 may include a pneumatic two-sided drive, and is preferably connected to tubular member 6.

Plunger rod 15 may also comprise a tubular portion having a first end proximate plunger 14 and one or more outlet openings 17 proximate first end. Plunger rod 15 may also have a second end proximate drive 8, the second end having an inlet opening 16. Preferably plunger rod 15 does not extend past plunger 14 and therefore outlet opening 17 may be located between plunger 14 and inlet opening 16.

In accordance with the embodiment shown in FIGS. 1-3, a flow area 18 is provided between the outer wall of plunger rod 15 and the inner wall of tubular member 6. Preferably, valve body 5 defines an inlet opening 19 into flow area 18, and tubular member 6 includes an outlet opening 20 located externally from product flow channel 2a. Therefore, a substance such as gas, liquid, solid, etc. may be received into flow area 18 via inlet opening 19 and expelled out of flow area 18 via outlet opening 20. Outlet opening 20 is preferably constructed and arranged not to interfere with the movement of tubular member 6. By way of non-limiting example, outlet opening 20 may be connected axially to tubular member 6.

Referring to FIG. 1, when plunger rod 15 is completely withdrawn, plunger 14 is also withdrawn and seals inlet opening 19. In the embodiment shown, a valve seat 5a extends radially inward on valve body 5 beyond valve seat 4a. Preferably plunger 14 contacts valve seat 5a when plunger 14 is withdrawn.

Referring to FIGS. 1-3, chamber 9 may include an inner cavity that is in fluid communication with the product flow channel 2a via outlet opening 4. By way of non-limiting example, chamber 9 may include a dosing chamber having a predetermined volume. In accordance with an exemplary embodiment, chamber 9 has a predetermined volume that corresponds to the product quantity to be withdrawn. Therefore, by filling chamber 9 with a quantity of the product (hereinafter product quantity) and subsequently emptying chamber 9, the desired product quantity may be withdrawn from the flow channel 2a. For example, if the product quantity is inserted into a withdrawal container 12, the quantity of the product contained in withdrawal container 12 may be known. Alternatively, chamber 9 may have a volume that is a fraction of the desired quantity to be withdrawn, thus requiring chamber 9 to be filled and emptied a predetermined number of times in order to withdraw the desired quantity from product flow channel 2a. For example, if two cups of the product is being withdrawn into a container and the product quantity of the chamber is one cup, the chamber 9 would be filled with the product and emptied into the container twice to fill the container with the desired two cups of the product.

Chamber 9 may have a generally cylindrical shape having an inner diameter similar to, preferably the same as the shape and diameter of outlet opening 4. Preferably outlet opening 4 has a generally round shape. It is to be understood that chamber 9 and outlet opening 4 may comprise a variety of shapes without deviating from the scope of the invention. For example, outlet opening 4 may have a generally square shape, and chamber may be generally tubular having a square shaped cross-section. Other shapes and arrangement are also envisioned.

Chamber 9 may further include a withdrawal opening 10, preferably on the opposite side of chamber 9 from outlet opening 4. Withdrawal opening 10 preferably has a shape and diameter corresponding to the shape and diameter of chamber 9 and outlet opening 4. In accordance with an exemplary embodiment, outlet opening 4, chamber 9 and withdrawal opening 10 are aligned with one another. Withdrawal opening 10 preferably may be sealed by a sealing device, such as a valve, by way of non-limiting example, a slide valve. Another example of a sealing device includes a seal 11 of a withdrawal container 12, wherein withdrawal container is preferably constructed and arranged to receive the product quantity from chamber 9.

A docking device 13 may be provided proximate withdrawal opening 10, docking device 13 being constructed and arranged to connect, preferably seal, withdrawal container 12 to chamber 9 to provide a fluid tight connection. Docking device 13 may comprise a variety of mechanisms, shape, and the like, and is preferably adapted according to the characteristics of the withdrawal container 12 to be received. By way of non-limiting example, docking device may include a pneumatic clamp.

Preferably, plunger 14 may be received within chamber 9 as plunger 14 extends away from tubular member 6. More preferably, plunger 14 has a diameter and shape similar to that of the inside of chamber 9 and outlet opening 4 such that plunger 14 covers the cross-section of chamber 9. Preferably, plunger 14 may be received through outlet opening 4 into chamber 9, and may continue toward withdrawal opening 10 in direction of the double headed arrow B.

In accordance with preferred embodiments of the invention, one or more sterilization systems may be provided. By way of non-limiting example, a sterilizing agent such as steam, sterile air or condensate may be utilized to sterilize the desired surface or area. Referring to the exemplary embodiments shown in FIGS. 1-3, chamber 9 may further include an inlet 21 and an outlet 22, which preferably extend perpendicularly to the direction of movement B of plunger 14. Preferably, inlet 21 and outlet 22 may be selectively sealed, and more preferably comprise valves for sealing.

A sterilization system 23 may be provided to sterilize the exterior wall of tubular member 6. Sterilization system 23 is preferably proximate opening 7 through which portions of tubular member 6 move in and out of flow channel 2a. Sterilization system 23 may include a sterilization chamber 24, which is preferably sealed off from flow channel 2a. An inlet 25 and an outlet 26 may be provided, both of which are preferably connected to sterilization chamber 24. In accordance with an exemplary embodiment of the invention, sterilization chamber 24 may receive portions of the tubular member 6 as tubular member 6 is displaced in and out of sterilization chamber 24. Preferably, a sterilizing agent is introduced into sterilization chamber 24 through inlet 25 and sterilizes the outer walls of the portions of the tubular member 6 located within sterilizing chamber 24 as tubular member 6 is displaced. Therefore, the outer wall of portion of tubular member 6 is preferably sterilized in sterilization chamber 24 immediately before it enters flow channel 2a.

In accordance with exemplary embodiments of the invention, one or more thermal sensors 27a, 27b, 27c may be provided to facilitate ensuring that the sterilization temperature is reached during sterilization. Thermal sensors 27a, 27b, 27c preferably also ensure that during the withdrawal of product quantity from chamber 9, the product is not inadvertently heated to the sterilization temperature, which may falsify the level during sampling, for example, when determining the degree of sterilization of the product. Preferably, first thermal sensor 27a monitors the temperature of chamber 9; second thermal sensor 27b monitors the temperature of sterilization system 23, and a third thermal sensor 27c monitors the temperature in flow area 18. It is to be understood, however, that more or less thermal sensors may be provided, and the location of the thermal sensors may be varied as a matter of application specific design choice.

The operation of system 1 will be described herein. Referring to FIG. 1, when system 1 is in a first, or idle, position, valve body 5 may seal outlet opening 4 and discharge plunger 14 may seal opening 19 of tubular member 6. Withdrawal opening 10 may be opened or closed, without deviating from the scope of the invention. The product may flow through flow channel 2a in flow direction F. Withdrawal container 12 is preferably pre-sterilized and is either empty or filled with a predetermined volume of a nutrient fluid, product, gas, or other substance.

Prior to withdrawing product quantity from product flow channel 2a into chamber 9, chamber 9 is preferably sterilized. Preferably, withdrawal opening 10 is sealed utilizing a seal, for example, seal 11 of withdrawal container 12. A sterilizing agent may be introduced into chamber 9 through inlet 21, thus sterilizing the inner walls of chamber 9, and removed through outlet 22. Preferably, the surface of seal 11 within chamber 9 and the surface of plunger 14 within chamber 9, both of which temporarily act as inner walls of chamber 9 are also sterilized. Alternatively, system 1 may be sterilized in its entirety, or product flow channel 2a, plunger 14 and chamber 9 may be sterilized prior to introducing the product into product flow channel 2a.

Preferably, a bag or pouch is used as withdrawal container 12 for receiving the product quantity and can be connected to docking device 13. Referring to FIG. 13, withdrawal container 12 may comprise a sealing plug 11b constructed and arranged to seal filling piece 11a from the inside, more specifically, from the interior of withdrawal container 12. Preferably, sealing plug 11b is removed from sealing plug 11 to open withdrawal container 12. Such a withdrawal container 12 may eliminate the need to sterilize a seal in advance before filling, more particularly, in the area of front face 11c of seal 11, especially if seal 11 is sterilized together with chamber 9 as described above. For example, withdrawal container 12 may be connected to chamber 9 and seal 11 may be held in place, preferably sealed in place, by docking device 13. Front face 11c of seal 11 preferably forms at least a portion of an inner wall of chamber 9, and is thus sterilized as described above.

A preferred temperature for sterilization is approximately 120° C. Once the temperature of chamber 9 falls below approximately 40° C. or a temperature at which sterilization does not take place, as preferably indicated by thermal sensor 27a, chamber 9 may be filled with the product. Chamber 9 may be cooled using a variety of methods, for example, by the product flowing past chamber 9 in product flow channel 2a.

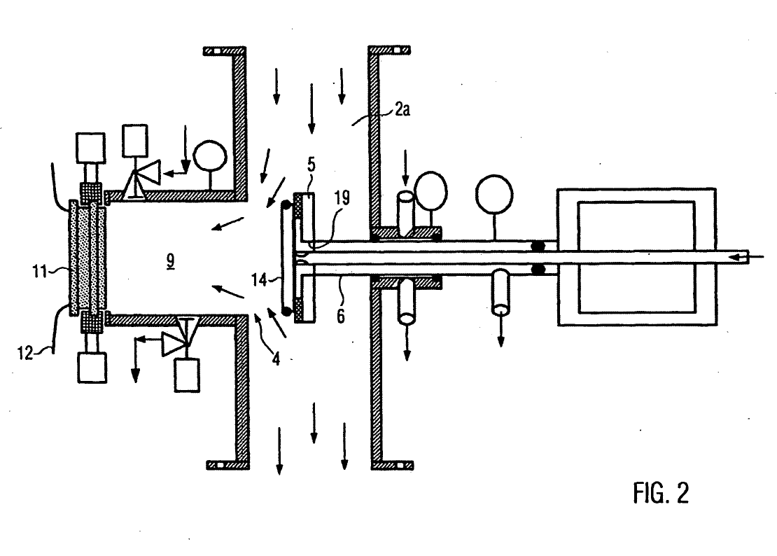

In order to fill chamber 9 with the product quantity, the double-seated valve formed of valve body 5 and plunger 14 may be displaced away from outlet opening 4, thus exposing outlet opening 4 to the products flowing within product flow channel 2a. Therefore, some of the product may exit product flow channel 2a and enter chamber 9. For example, the product may, by the force of gravity, enter and fill chamber 9. An embodiment of such a configuration is illustrated in FIG. 2. Preferably, opening 19 of tubular member 6 remains closed by plunger 14.

Once chamber 9 has been filled with the product quantity, tubular member 6 may be displaced toward chamber 9, and therefore the double-seated valve formed of the valve body 5 and plunger 14 may be moved toward valve seat 4a until valve body 5 contacts valve seat 4a, thus closing and sealing outlet opening 4. Preferably simultaneously, the exterior of tubular member 6 moves through sterilization chamber 24 and is sterilized. Therefore, the exterior of tubular member 6 that enters product flow channel 2a is preferably sterilized and does not contaminate the product or product flow channel 2a.

After outlet opening 4 has been sealed, seal 11 of withdrawal container may be released, thus permitting some of the product to enter withdrawal container 12. In accordance with an exemplary embodiment, plunger 14 may push the product toward and into withdrawal container 12. Referring to FIG. 3, if a bag or pouch having plug 11b is utilized, the pressure applied by plunger 14 forces plug 11b out and removes plug 11b from filling piece 11a. Alternatively, a separate device may be utilized to remove plug 11b from filling piece 11a without deviating from the scope of the invention. Consequently upon removal of plug 11b from filling piece 11a, some of the product may enter withdrawal container 12, preferably by plunger 14 pushing the product toward withdrawal container 12 until the entire product quantity has been withdrawn from chamber 9 into withdrawal container 12.

During this withdrawal process, tubular member 6 preferably remains in place and plunger 14 is displaced by the movement of plunger rod 15, as shown in FIG. 3. Preferably, valve 5 is connected to tubular member 6 and has a diameter greater than the diameter of outlet opening 4, thus preventing tubular member 6 from entering chamber 9. Therefore, whereas tubular member 6 remains in place, plunger rod 15 preferably moves toward withdrawal container 12, thus entering and traveling through chamber 9 as plunger 14 pushes the product quantity into withdrawal container 12. In accordance with an embodiment of plunger 14, plunger 14 may include a scraper connected to the outer perimeter of plunger 14 to scrape the inner walls of chamber 9 to facilitate complete removal of the product from within chamber 9 into withdrawal container 12.

Additionally, as plunger 14 is displaced away from valve 5 toward withdrawal container 12, opening 19 to flow path 18 is opened. Preferably, a sterilizing agent is introduced through the inlet opening 16 of plunger rod 15, the sterilizing agent which travels along the length of plunger rod, exits plunger rod via outlet opening 17 and into chamber 9 behind plunger 14, then into flow path 18. Therefore, the air behind plunger 14 and the exterior of plunger rod 15 may be sterilized. This preferably prevents any non-sterilized product or non-sterile air from being re-introduced into product flow channel 2a.

The product quantity is preferably completely withdrawn into withdrawal container 12, preferably by plunger 14 being extended until plunger 14 contacts filling piece 11a as shown in FIG. 3. Once this position is reached, plug 11b may be reinserted into or otherwise connected to filling piece 11a to seal withdrawal container 12. If withdrawal container 12 is constructed to receive multiple product quantities, withdrawal container may remain connected to docking device 13 and the process may be repeated as necessary. If withdrawal container 12 is constructed to receive a single product quantity, withdrawal container 12 may be removed and a new withdrawal container 12 may be connected. Alternatively, withdrawal opening 10 may remain open.

Subsequently, plunger 14 is preferably moved toward valve 5 until plunger 14 contacts valve 5 to once again form the double-seated valve. As plunger 14 is moved toward valve 5, the sterilizing agent located behind plunger 14 may be pushed out through opening 19 into flow path 18 and through outlet 20. Once plunger 14 contacts valve 5, the process of filling chamber 9 and withdrawing the product quantity may be repeated. Alternatively, chamber 9 may be sterilized by permitting a sterilizing agent to fill chamber 9 by opening inlet 21 while keeping outlet 22 closed. The sterilizing agent is preferably removed through outlet 22 prior to filling chamber 9.

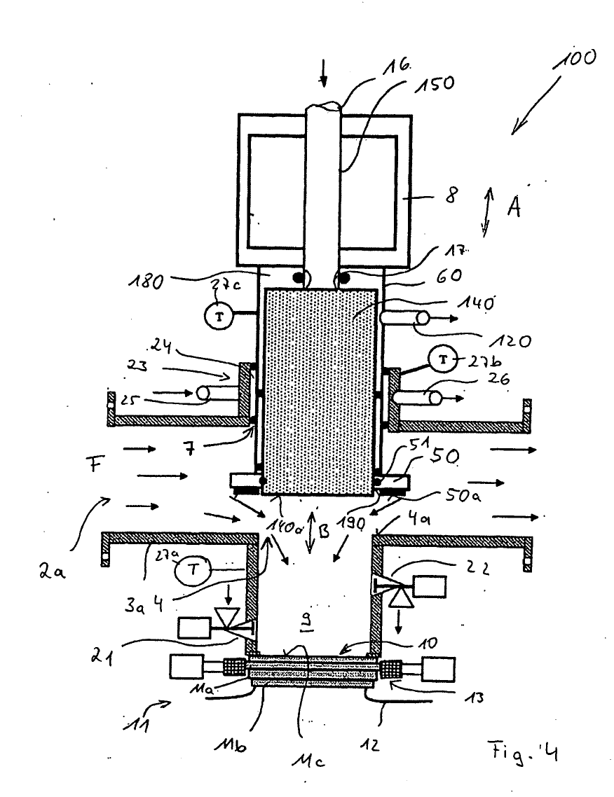

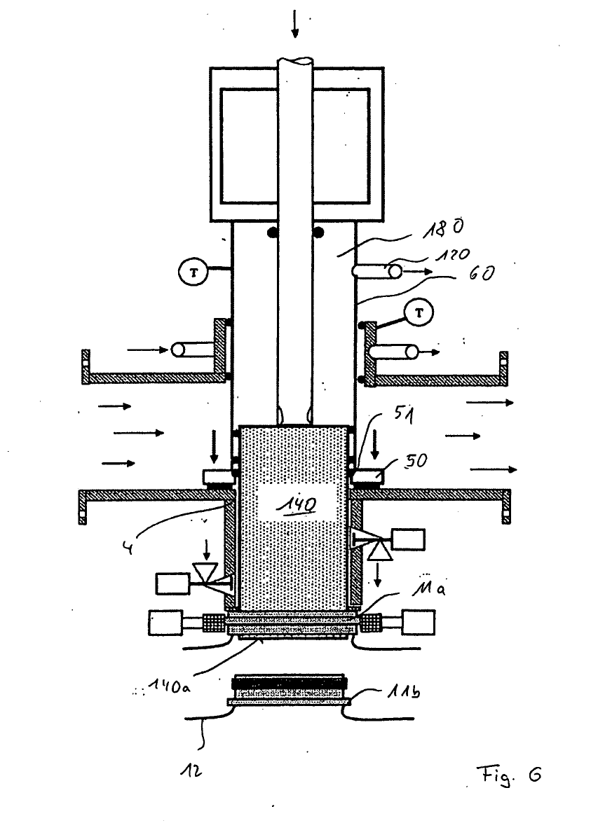

Reference is made to FIGS. 4-6, wherein an alternate embodiment of a system 100 is shown, which preferably also provides withdrawal of a product quantity from a product flow by volume. The structure and manner in which device 100 works has similarities to that of the embodiment of FIGS. 1-3, whereby same or comparable components are identified with the same reference numbers as in FIGS. 1-3. Such components will not be described in reference to FIGS. 4-6.

As shown in FIGS. 4-6, an embodiment of device 100 includes a tubular member 60 movable within flow channel 2a through which the product flows. Tubular member 60 can house a displaceable plunger 140 connected to a plunger rod 150, wherein plunger 140 can slide in and out of tubular member 60. Tubular member 60 preferably includes a valve body 50 at a first end, valve body 50 preferably including a valve surface 50a which preferably contacts valve seat 4a within flow channel 2a to seal outlet opening 4 of dosing chamber 9.

The valve body 50 preferably defines an opening 190 leading into a flow area 180 defined by the inner wall of tubular member 60 and the outer wall of plunger rod 150. More specifically, the space between the plunger rod 150 and tubular member 60 is referred to as the flow area 180. Flow area 180 is preferably closed at a second end of tubular member 60 by a drive 8 for controlling the displacement of tubular member 60 and plunger rod 150. Referring to FIGS. 1-6, opening 190 of valve body 50 of FIGS. 4-6 may be larger than opening 19 of valve body 5 of FIGS. 1-3.

Preferably, opening 190 can be closed by plunger 140 and a sealing ring 51 as shown in FIG. 4 when plunger 140 is in a first retracted state wherein the discharge surface 140a of plunger 140 is flush and aligned with the surface of valve surface 50a. Sealing ring 51 may be connected to valve body 50 and extend inward into opening 190 such that there is no gap between valve body 50, sealing ring 51 and plunger 140.

In accordance with an exemplary embodiment, plunger 140 can have a cylindrical shape extending within valve spindle 60, the plunger 140 having a round cross section. Preferably, plunger 140 is sized and shaped such that plunger 140 substantially fills chamber 9, more preferably fills chamber 9 completely or almost completely, between outlet opening 4 and withdrawal opening 10. As shown in FIGS. 4-6, plunger 140 may be longer than the depth of chamber 9, and more specifically, longer than the distance between outlet opening 4 and withdrawal opening 10. Preferably, plunger 140 can be extended until a part of plunger 140 is received within and preferably through withdrawal opening until plunger 140 contacts filling piece 11a or into withdrawal container 12.

In the embodiment shown in FIGS. 4-6, plunger 140 has a smaller diameter than the diameter of chamber 9. Such an arrangement may facilitate sealing outlet opening 4 without sliding a seal over the limiting edge of the surface of valve seat 4a.

Sealing ring 51 may also act as a plunger scraper by scraping or otherwise cleaning or removing products or other substance on the surface of plunger 140 as plunger 140 moves relative to valve body 50 and past sealing ring 51. Therefore, after being inserted into chamber 9 to displace the contents thereof into withdrawal container 12, plunger 140 can be withdrawn into tubular member 60. While plunger 140 is being withdrawn, the portion of plunger 140 that had extended out of tubular member 60 will preferably pass sealing ring 51 prior to withdrawing into tubular member 60, thus being cleaned prior to entering flow area 180 within tubular member 60.

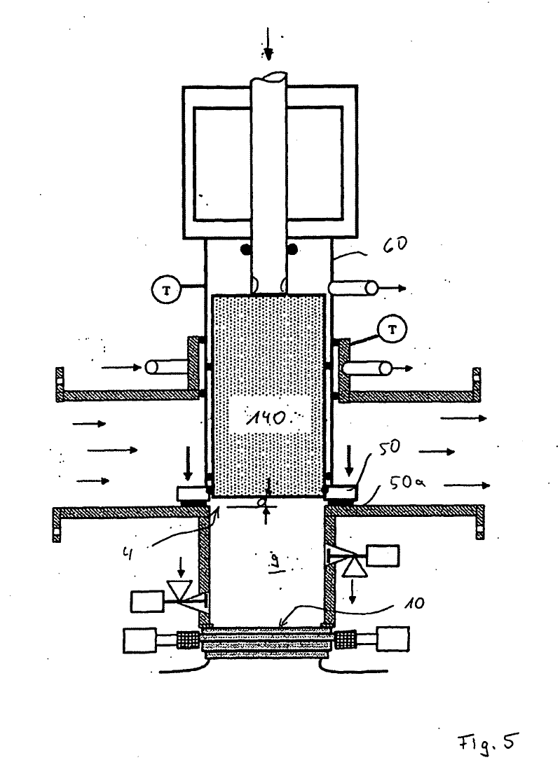

Referring to FIG. 5, plunger 140 may withdraw past valve surface 50a a distance a, to a second retracted state, such that discharge surface 140a is set back from valve surface into tubular member 60 by distance a.

Referring to FIGS. 4-6, plunger rod 150 may include at least one inlet opening 16 and at least one outlet opening 17. Outlet opening 17 is preferably located proximate plunger 140 at an end opposite to discharge surface 140a. Tubular member 60 can include an outlet 120 located externally to flow channel 2a. A gas or other substance may flow into flow area 180 via outlet opening 17 and exit flow area 180 via outlet 120. Preferably, outlet 120 can empty flow area 180.

In accordance with an exemplary embodiment, valve body, tubular member 60 and plunger 140 are arranged coaxially and can be moved together as a unit or independently of one another, preferably in direction A consistent with the shared axis. Drive 8 preferably controls such movements.

In accordance with an embodiment of system 100, a bypass path may be provided within channel 2 around valve body 50 and/or tubular member 60. A bypass path may facilitate the flow of products within flow channel 2a in flow direction F when tubular member 60 is extended across flow channel 2a toward chamber 9. Preferably, the flow rate can be maintained.

An exemplary operation of system 100 will be described herein. Drive 8 can cause withdrawal of valve body 50, tubular member 60 and plunger 140 away from outlet opening 4. Plunger 140 is preferably withdrawn into the first retracted state wherein discharge surface 140a is flush and aligned with valve surface 50a. Product preferably can flow into chamber 9 from flow channel 2a.

Once chamber 9 is filled with the product, valve body 50, tubular member 60 and plunger 140 can be moved, preferably together, toward chamber 9 until valve surface 50a contacts valve seat 4a, thus sealing outlet opening 4. Plunger 140 can be withdrawn to the second retracted state wherein discharge surface 140a is withdrawn into tubular member 60 a distance a from valve surface 50a.

The product can be pressed into chamber 9 as outlet opening 4 is being sealed. It may be desirable to relieve the pressure, for example, if the product is a liquid, which is not compressible. By withdrawing plunger 140 a distance a, the pressure is preferably reduced, removed or prevented entirely. Distance a may be a few millimeters and provide this benefit.

After chamber 9 is filled with the product and outlet opening 4 is closed, withdrawal opening 10 can be opened and plunger 140 can be extended into chamber 9, and can thus push the product out of chamber 9 into withdrawal container 12. While plunger 140 is being extended into chamber 9, a sterilization agent, such as steam, is preferably introduced through opening 16 and opening 17 into flow area 180. The sterilization agent preferably fills the area behind plunger 140 inside tubular member 60.

Once the product has been discharged into withdrawal container 12, plunger 140 can be further extended into and preferably through withdrawal opening 10, more preferably through filling piece 11a. Such a step may ensure that no product residue remains in filling piece 11a and that plug 11b or the bag or pouch or other container valve seals tightly in filling piece 11a.

After the predetermined product quantity has been discharged, plunger 140 can be withdrawn simultaneously as filling piece 11a is closed with plug 11b (or bag or pouch valve) of withdrawal container. Plunger 140 preferably passes sealing ring 51, which scrapes off any product residue on the surface of plunger 140. Valve body 50 preferably remains in place and outlet opening 4 thus remains sealed. As plunger 140 is being retracted, the sterilization agent is preferably removed, more preferably pressed out of flow path 180 via outlet 120. Once plunger 140 is withdrawn to either the first retracted state or the second retracted state, valve body 50 and tubular body 60 can be moved away from outlet opening 4 to open outlet opening 4 and permit product to flow into chamber 9. The same steps can be repeated to withdraw additional product quantities from flow channel 2a.

Dosing chamber 9 can be sterilized in a manner similar to that described above, wherein a pre-rinsing with a condensate provided by a condensate collector can be performed to remove the product film on the walls of chamber 9, which may result from the smaller diameter of plunger 140 than chamber 9. Sterilization can be performed subsequently using steam or other suitable agent.

Sterilization of the outer wall of tubular member 60 can be performed in the manner described above. The outer wall of plunger 140 can be sterilized using steam within flow area 180, whereby the steam can also sterilize sealing ring 51. One or more guiding members can be provided along plunger 140 and/or plunger rod 150 to facilitate the movement of plunger 140. The sterilization agent, such as steam, may also provide lubrication of sealing ring 51 to facilitate movement of plunger 140 past sealing ring 51. Chamber 9 can also be ventilated with sterilized air or another sterilization agent after plunger 140 is pulled back but before valve body 50 is removed from valve seat 4a.

System 1, 100 can also be used to fill a container with quantities greater than the product quantity of chamber 9 by filling the container multiple times as described above. System 1, 100 can also be used for customary filling in traffic vessels, adapted to various withdrawal containers, or otherwise modified without deviating from the scope of the invention. System 1, 100 can also be used to withdraw product from containers or the like.

The examples provided are merely exemplary, as a matter of application specific to design choice, and should not be construed to limit the scope of the invention in any way.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. For example, rather than filling chamber 9 and withdrawing the product quantity multiple times to fill a larger withdrawal container 12, outlet opening 4 may remain open until the desired quantity of the product has been received by withdrawal container 12, without deviating from the scope of the invention as a matter of application specific to design choice. Additionally, other alterations can be made, as a way of non-limiting example, different withdrawal containers, valves, plungers, valve seats, arrangements and designs thereof, direction of activation, etc. may be utilized as a matter of application specific to design choice, without deviating from the scope of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

1-18. (canceled)

19. A system for withdrawing a quantity of a product from a product stream, the system comprising:
a housing defining a flow channel, the product housing constructed and arranged to have a volume of products flowing through the flow channel, the housing having an outlet opening;
a chamber connected to the housing, wherein the chamber is in fluid communication with the flow channel via the outlet opening; and
a displaceable assembly comprising:
a tubular member defining a flow cavity therein;
a valve body connected to the tubular member;
a plunger displaced within the tubular member, the plunger being axially displaceable with respect to the tubular member and to the valve body;
wherein the displaceable assembly is displaceable toward and away from the chamber within the flow channel; and
wherein the plunger is constructed and arranged to be inserted into the chamber.

20. The system of claim 19, further comprising an inlet through which a gas can flow into the flow cavity and outlet through which the gas can flow out of the flow cavity.

21. A system for withdrawing a quantity of a product from a product stream, the system comprising:
a housing defining a flow channel, the product housing constructed and arranged to have a volume of products flowing through the flow channel at a flow direction, the housing having an outlet opening;
a chamber connected to the housing, wherein the chamber defines a chamber cavity in fluid communication with the flow channel via the outlet opening, the dosing chamber including
an inlet through which gas can be introduced into the chamber;
an outlet through which gas can be expelled from the chamber;
a withdrawal opening through which product can be expelled from the chamber; and
a displaceable assembly comprising:
a tubular member defining a flow cavity therein, the tubular member having an outlet for expelling gas within the flow cavity;
a valve body connected to the tubular member, the valve body having a sealing member constructed and arranged to seal the outlet opening when the displaceable assembly is in an extended state;
a plunger displaced within the tubular member, the plunger being axially displaceable with respect to the tubular member and to the valve body;
a hollow plunger rod connected to the plunger, the plunger rod having one or more inlets through which a gas can be introduced into the flow cavity;
a first drive mechanism connected to the displaceable assembly, the first drive mechanism constructed and arranged to actuate the displacement of the displaceable assembly; and
a second drive mechanism connected to the plunger rod, the second drive mechanism constructed and arranged to actuate the displacement of the plunger with respect to the tubular member and the valve body;
wherein the displaceable assembly is displaceable toward and away from the chamber within the flow channel at a direction perpendicular to the flow direction; and
wherein the plunger is constructed and arranged to be inserted into the chamber.

22. The system of claim 21, further comprising a docking assembly connected to the chamber, the docking assembly being constructed and arranged to connect to a withdrawal container.

23. A system for withdrawing a quantity of a product from a housing, the system comprising:
a housing comprising a first volume of products, the housing having an outlet opening and a housing cavity;
a chamber for receiving a second volume of products, the chamber being connected to the housing and further being in fluid communication with the housing cavity;
a displaceable assembly comprising:
a tubular member defining a flow cavity therein;
a valve body connected to the tubular member;
a plunger displaced within the tubular member, the plunger being axially displaceable with respect to the tubular member and to the valve body;
wherein the displaceable assembly is displaceable toward and away from the chamber within the housing; and
wherein the plunger is constructed and arranged to be inserted into the chamber.

24. A system for withdrawing a quantity of a product from a housing, the system comprising:
a housing defining a flow channel, the product housing constructed and arranged to have a volume of products flowing through the flow channel, the housing having an outlet opening;
a chamber connected to the housing, the chamber defining a chamber cavity, wherein the chamber cavity is in fluid communication with the flow channel via the outlet opening; and
a sealing assembly having a valve body constructed and arranged to selectively seal the outlet opening; and
a plunger displaceable coaxially relative to the valve body into the chamber.

25. The system of claim 24, wherein the chamber includes a wall defining a withdrawal opening, wherein the plunger is constructed and arranged to displace a predetermined quantity of the product from within the chamber toward the withdrawal aperture as the plunger is displaced into the chamber.

26. The system of claim 24, wherein the valve body defines a valve opening, and the plunger is constructed and arranged to seal the opening.

27. The system of claim 26, wherein the outlet opening, the chamber cavity, the withdrawal opening and the valve opening are aligned and flush to one another.

28. The system of claim 25, further comprising a docking device connected to the chamber proximate the withdrawal opening, the docking device being constructed and arranged to connect a withdrawal container to the chamber.

29. The system of claim 24, wherein the dosing chamber includes at least one sterilization opening.

30. The system of claim 24, wherein the housing includes a second opening through which the sealing assembly extends into the housing, the second opening being positioned on the opposite side of the flow channel from the outlet opening.

31. The system of claim 30, further comprising a sterilization chamber connected to the housing proximate the second opening.

32. The system of claim 24, wherein the sterilization assembly includes a tubular member.

33. The system of claim 24, wherein the plunger and the valve body form a double-seated valve.

34. The system of claim 24, wherein the valve body is connected to a tubular member defining a flow path.

35. The system of claim 34, wherein the flow path extends into the chamber.

36. The system of claim 34, further comprising a plunger rod connected to the plunger, the plunger rod extending through the tubular member.

37. The system of claim 34, further comprising a hollow plunger rod defining a channel therein, the hollow plunger rod connected to the plunger and having an aperture through which the flow path extends into the chamber.

38. The system of claim 32, wherein the plunger is axially displaceable within the tubular member, the plunger constructed and arranged to seal a first end of the tubular member.

39. The system of claim 24, wherein the plunger has an axial length greater than or equal to the axial length of the chamber.

40. The system of claim 32, wherein the plunger includes a first end proximate the valve body, the valve body having a surface facing the outlet opening, wherein the plunger has a retracted position wherein the first end of the plunger is retracted past the surface of the valve body such that the distance between the first end of the plunger and the outlet opening is greater than the distance between the surface of the valve body and the outlet opening.

41. A method of withdrawing a predetermined quantity of a product from a housing, the method comprising:
providing a housing having a wall defining a channel through which a product stream passes;
determining a quantity of the product being removed from a product stream by determining the volume of a chamber;
providing a chamber having the determined volume;
connecting the chamber to the product stream by an outlet opening therebetween;
connecting a withdrawal container to the dosing chamber;
providing a the product along the product flow channel;
providing a sealing assembly having a valve body and a plunger;
moving the sealing assembly away from the outlet opening;
filling the chamber with the quantity of the product;
moving the sealing assembly toward the outlet opening until the valve body contacts the wall of the housing;
sealing the outlet opening so that product from within the product flow channel does not enter the chamber;
moving the plunger coaxially relative to the valve body into the dosing chamber while maintaining the valve body in place and maintaining the outlet opening sealed; and
pushing the quantity of the product within the dosing chamber with the plunger into the withdrawal container.

42. The method of claim 41, further comprising sterilizing the chamber by introducing a sterilizing agent into the chamber.

43. The method of claim 41, further comprising sterilizing a portion of the sealing assembly by introducing a sterilizing agent proximate the displaceable member.

44. The method of claim 42, further comprising sterilizing a portion of the sealing assembly prior to displacing the sealing assembly across the product flow channel.

45. The method of claim 43, further comprising sterilizing the chamber simultaneously with expelling the quantity of the product from within the chamber through the withdrawal aperture.

46. The method of claim 41, further comprising withdrawing the plunger away from the chamber after sealing the outlet opening.
